(19) United States
(12) Patent Application Publication
(10) Pub. No.: US 2007/0205721 A1
(43) Pub. Date: Sep. 6, 2007

(54) Method of manufacturing display device including oxidized porous silicon material-based emission source

(76) Inventor: Seung-Hyun Son, Suwon-si (KR)

Correspondence Address: Robert E. Bushnell, Suite 300, 1522 K Street, N. W., Washington, DC, 20005, US

(21) Appl. No.: 11/709,755

(22) Filed: Feb. 23, 2007

(30) Foreign Application Priority Data
Mar. 4, 2006 (KR) 10-2006-0020718

(51) Int. Cl. H01J 17/49

(52) U.S. Cl. 313/582

(57) ABSTRACT

Provided are a method of manufacturing a display device including an oxidized porous silicon (OPS) material-based emission source and a display device manufactured using the method. A first and second panels, each of which includes one of sodium oxide (Na₂O) and potassium oxide (K₂O), are prepared. An OPS material-based emission source is formed on the first panel, and a silicon spacer enclosing the OPS material-based emission source is formed on the first panel. The second panel is anodic bonded to the silicon spacer, so that the first and the second panels are assembled together.

### CLAIM OF PRIORITY

This application makes reference to, incorporates the same herein, and claims all benefits accruing under 35 U.S.C. §119 from an application for METHOD OF MANUFACTURING DISPLAY DEVICE COMPRISING OXIDIZED POROUS SILICON MATERIAL-BASED ELECTRON EMISSION SOURCE earlier filed in the Korean Intellectual Property Office on 4 Mar. 2006 and there duly assigned Ser. No. 10-2006-0020718.

### BACKGROUND OF THE INVENTION

1. Field of the Invention

The present invention relates to a method of manufacturing a display device including an oxidized porous silicon (OPS) material-based emission source, and more particularly, to a method of manufacturing a display device having improved electron emission characteristics of an OPS layer by suppressing contamination of a surface of the OPS layer during a bonding process of first and second panels and a display device manufactured using the method.

2. Description of the Related Art

Generally, a plasma display panel (PDP) displays an image using a phenomenon of electrical gas discharge. Due to excellent display characteristics such as high brightness and a wide viewing angle, the PDP has been popular for a flat panel display device. In a PDP, plasma discharge occurs by applying an alternating current (AC) or direct current (DC) voltage between electrodes, and ultraviolet (UV) rays generated through the discharge excite a phosphor material, which emits visible light. PDPs may be classified into an AC discharge type and a DC discharge type according to a discharge method. PDPs may also be classified into a facing discharge type or a surface discharge type according to an electrode arrangement.

FIG. 1 is an exploded perspective view of a plasma display panel. Referring to FIG. 1, a PDP may include rear panel 2 and front panel 10 facing rear panel 2. A plurality of barrier ribs 8 are interposed between rear panel 2 and front panel 10. Accordingly, discharge space 15 is defined by rear panel 2, front panel 10, and the plurality of barrier ribs 8. Discharge gas such as xenon (Xe) is filled in discharge space 15. A plurality of discharge cells are formed by partitioning discharge space 15 with the plurality of barrier ribs 13, which are formed at predetermined intervals to prevent electrical and optical cross-talk between adjacent discharge cells. In more detail, in the PDP, a plurality of address electrodes 4 are formed on an inner surface of rear panel 2, and first dielectric layer 6 is formed to cover address electrodes 4. Phosphor layer 9, which produces red, green, or blue light, is formed on first dielectric layer 6. First and second sustain electrodes 11a and 11b are formed on an inner surface of front panel 10. First and second bus electrodes 12a and 12b are formed on sustain electrodes 11a and 11b, respectively, to reduce the line resistance of stain electrodes 11a and 11b. Second dielectric layer 13 is formed to cover first and second sustain electrodes 11a and 11b and first and second bus electrodes 12a and 12b. Protective layer 14, which may be made of magnesium oxide (MgO), covers second dielectric layer 13. MgO protective layer 14 prevents second dielectric layer 23 from being damaged by plasma sputtering. MgO protective layer 14 emits secondary electrons during a plasma discharge process, thereby lowering a discharge voltage.

In a PDP, plasma discharge occurs as the discharge gas inside the discharge cells is activated to an excited state. As the discharge gas relaxes from the excited state, it emits UV rays. The UV rays excite phosphors to emit visible rays through front panel 10, which eventually forms an image.

Manufacturing technology of the PDP, however, still has several problems to be solved in order to produce high quality displays. For example, stripe-type barrier ribs built in the contemporary PDP are formed through a paste printing method. Therefore, they are constructed in a tapered shape toward upper portions thereof. Although the manufacturing of the stripe-type barrier ribs can be relatively simple, the tapered barrier ribs could cause a cross-talk between adjacent discharge cells, which is undesirable in achieving a highly luminous, highly efficient display device.

In particular, in the contemporary manufacturing technology of display devices, in order to package a display device such as a PDP or a field emission device (FED), organic paste is applied on an upper panel or on a lower panel, and is heated at high temperature of approximately 400° C., thereby combining the upper and lower panels with each other. During the heating process, inner surfaces of the discharge cells may be contaminated by organic matter drained from the discharge cells in the form of a gaseous phase, thereby undesirably degrading discharge and characteristics of the display device.

### SUMMARY OF THE INVENTION

The present invention provides a method of manufacturing a display device having improved electron emission characteristics of an oxidized porous silicon (OPS) layer by preventing contamination of a surface of the OPS layer during a bonding process of first and second panels. The present invention also provides a display device manufactured using the method.

According to an aspect of the present invention, there is provided a method of manufacturing a display device, which includes steps of preparing a first panel that includes sodium oxide (Na₂O) or potassium oxide (K₂O), preparing a second panel that includes sodium oxide (Na₂O) or potassium oxide (K₂O), forming an oxidized porous silicon material-based emission source on an inner surface of the first panel, forming a silicon spacer on the inner surface of the first panel where the silicon spacer encloses the oxidized porous silicon material-based emission source, and anodic bonding the second panel to the silicon spacer in a manner that an inner surface of the second panel faces the inner surface of the first panel.

Each of the first panel and the second panel can be made of a material such as glass or a plastic material, which has a coefficient of thermal expansion being substantially the same as a coefficient of thermal expansion of silicon. The glass for the first and second panel can be low expansion borosilicate glass.

The step of forming the oxidized porous silicon material-based emission source may includes steps of forming a cathode electrode on the inner surface of the first panel, forming an oxidized porous silicon layer on the cathode electrode, and forming a grid electrode on the oxidized porous silicon layer.

The silicon spacer may have a height and width, each of which is no greater than 100 μm, preferably no greater than 10 μm.

The step of anodic bonding the second panel may include steps of heating the first panel and the second panel to temperature no less than 200° C., and applying a direct current voltage to each of the silicon spacer, the first panel, and the second panel. The DC voltage is 600 V or greater. Negative (−) voltage is applied to the first and second panels, and positive (+) voltage is applied to the silicon spacer.

In addition, the manufacturing method of the display device may further include steps of forming a phosphor layer on an inner surface of the second panel. More preferably, the manufacturing method of the display device may further include steps of forming an anode electrode on an inner surface of the second panel, and forming a phosphor layer on the anode electrode.

According to another aspect of the present invention, there is provided a display device, which includes a first panel that includes sodium oxide (Na₂O) or potassium oxide (K₂O), a second panel that includes sodium oxide (Na₂O) or potassium oxide (K₂O), an oxidized porous silicon material-based emission source formed on an inner surface of the first panel, and a silicon spacer formed on the inner surface of the first panel. The silicon spacer encloses the oxidized porous silicon material-based emission source. The second panel is bonded to the silicon spacer in a manner that an inner surface of the second panel faces the inner surface of the first panel.

The oxidized porous silicon material-based emission source may includes a cathode electrode formed on the inner surface of the first panel, an oxidized porous silicon layer formed on the cathode electrode, and a grid electrode formed on the oxidized porous silicon layer.

The display device may further include an anode electrode formed on the inner surface of the second panel, and a phosphor layer formed on the anode electrode. A bond of silicon-oxygen-silicon may be formed between the second panel and the silicon spacer.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded perspective view of a plasma display panel;

FIG. 2 is a schematic cross-sectional view of a display device, which includes an oxidized porous silicon (OPS) material-based emission source, constructed as an embodiment of the present invention; and

FIGS. 3A through 3K are diagrams illustrating the manufacturing process of a display device, which includes an OPS material-based emission source, constructed as an embodiment of the present invention.

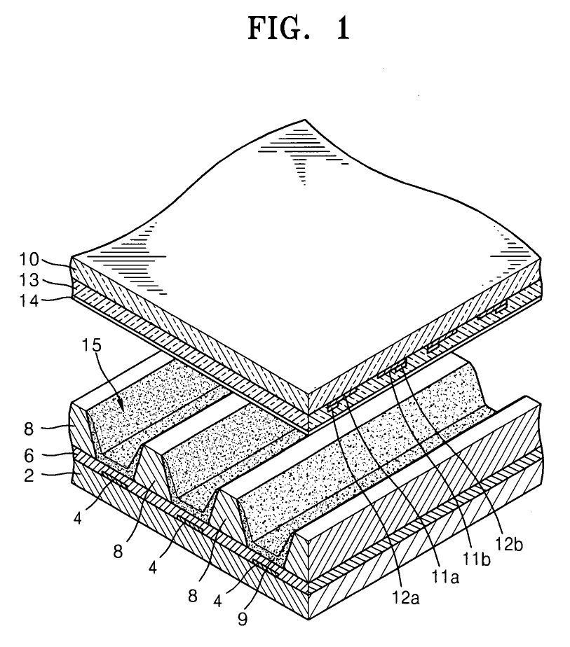

### DETAILED DESCRIPTION OF THE INVENTION

The present invention will now be described in detail with reference to the accompanying drawings, in which exemplary embodiments of the invention are shown. In the drawings, the size and relative sizes of layers and regions may be exaggerated for clarity.

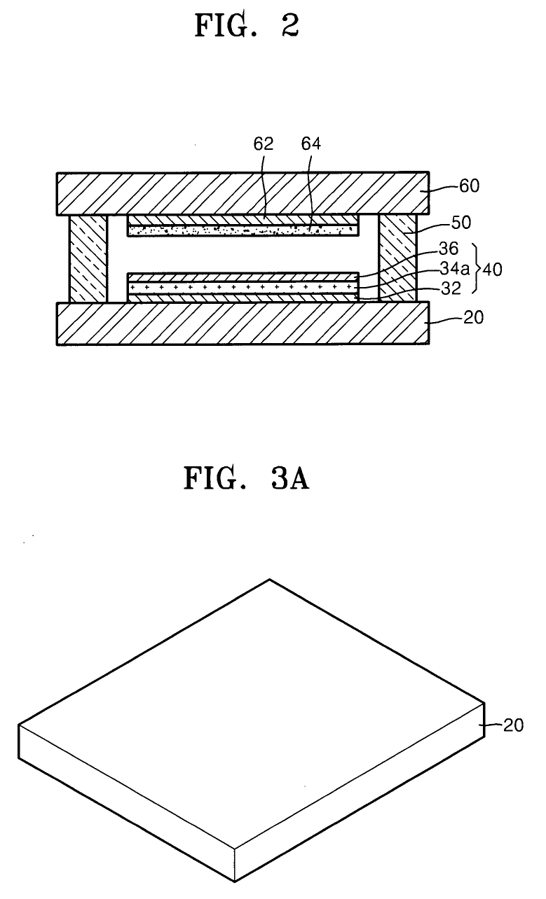

FIG. 2 is a schematic cross-sectional view of a display device, which includes an oxidized porous silicon (OPS) material-based emission source, constructed as an embodiment of the present invention. Referring to FIG. 2, the display device includes first panel 20, second panel 60 that faces first panel 20, silicon spacer 50 interposed between first panel 20 and second panel 60 to maintain a predetermined gap between first panel 20 and second panel 60, and OPS material-based emission source 40 formed on an inner surface of first panel 20. Herein, surfaces of first panel 20 and second panel 60 that face each other are referred to as inner surfaces of first panel 20 and second panel 60, respectively.

OPS material-based emission source 40 includes cathode electrode 32, oxidized porous silicon (OPS) layer 34a formed on cathode electrode 32, and grid electrode 36 formed on OPS layer. In addition, anode electrode 62 is formed on an inner surface of second panel 60, and phosphor layer 64 is sequentially formed on anode electrode 62. The stack of anode 62 and phosphor layer 64, which is formed on second panel 60, is arranged to face OPS material-based emission source 40, which is formed on first panel 20.

In the display device having the aforementioned structure, if predetermined voltages, e.g., Vc, Vg, and Va, are applied to cathode electrode 32, grid electrode 36, and anode electrode 62, respectively, satisfying the inequality of Vc<Vg<Va, electric field is created between each two of these electrodes 32, 36, and 62. Driven by the electric field, electrons are supplied from cathode electrode 32 to OPS layer 34a. The electrons are accelerated while passing through OPS layer 34a. The accelerated electrons emitted from OPS layer 34a migrate toward anode electrode 62. The phosphor layer 64 is excited by the accelerated electrons and generates visible light, which is emitted through second panel 60, thereby forming an image.

The principle of acceleration and emission of electrons in OPS layer 34a will now be described in detail. Silicon nano crystals contained in OPS layer 34a have a diameter of approximately 5 nm, which is much smaller than a mean free path of electrons that is approximately 50 nm. Accordingly, collision probability of the electrons contained in the silicon nano crystals is very low, and most of the electrons pass through the silicon nano crystals without collision until the electrons reach an interfacial surface between the silicon nano crystal and other neighboring nano crystal. Meanwhile, in OPS layer 34a, an ultra thin oxide film is formed between silicon nano crystals. If a predetermined voltage is applied through OPS layer 34a, the oxide film produces a region of electric field in OPS layer 34a. The oxide film is so thin that the electrons can pass through the oxide film by tunneling effect. Therefore, the electrons can be accelerated in the region of electric field produced in OPS layer 34a. Accordingly, a display device of the present invention having an OPS layer may have higher luminous efficiency than a contemporary display device.

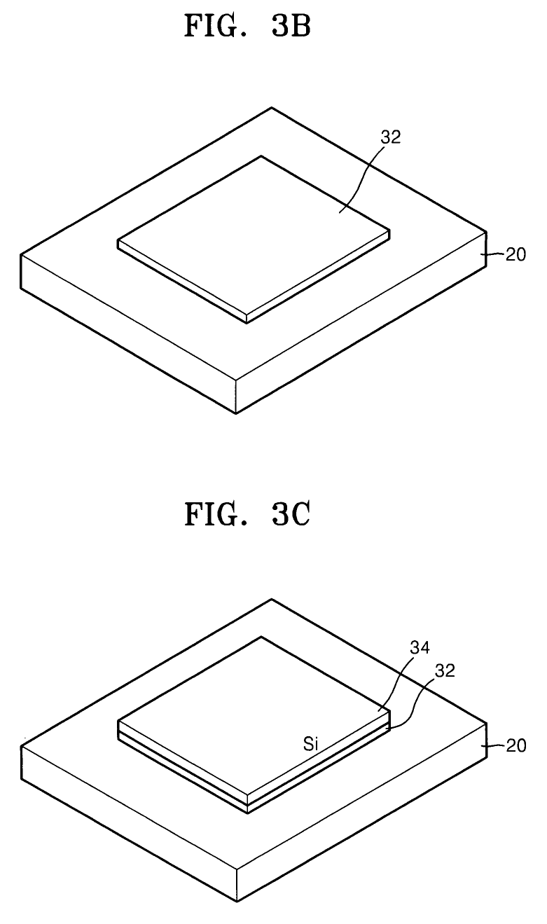

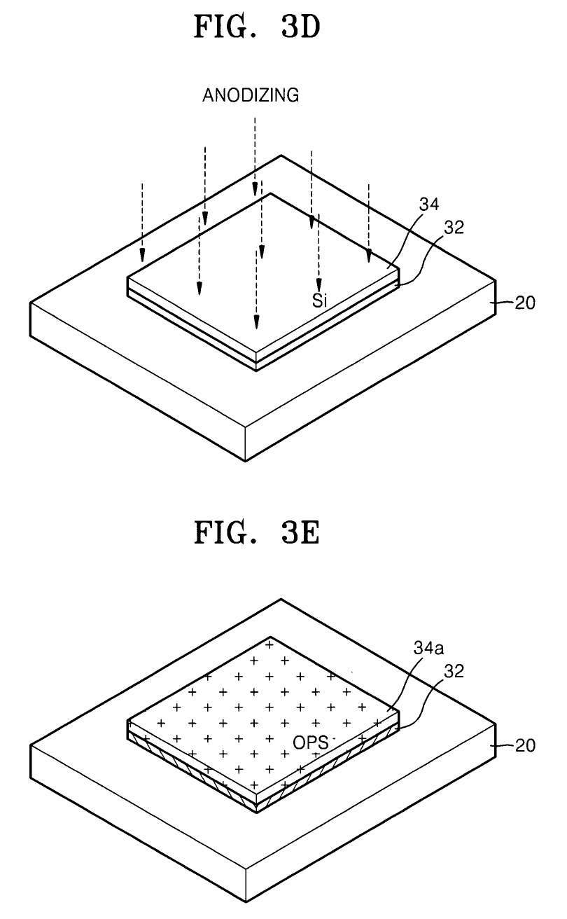

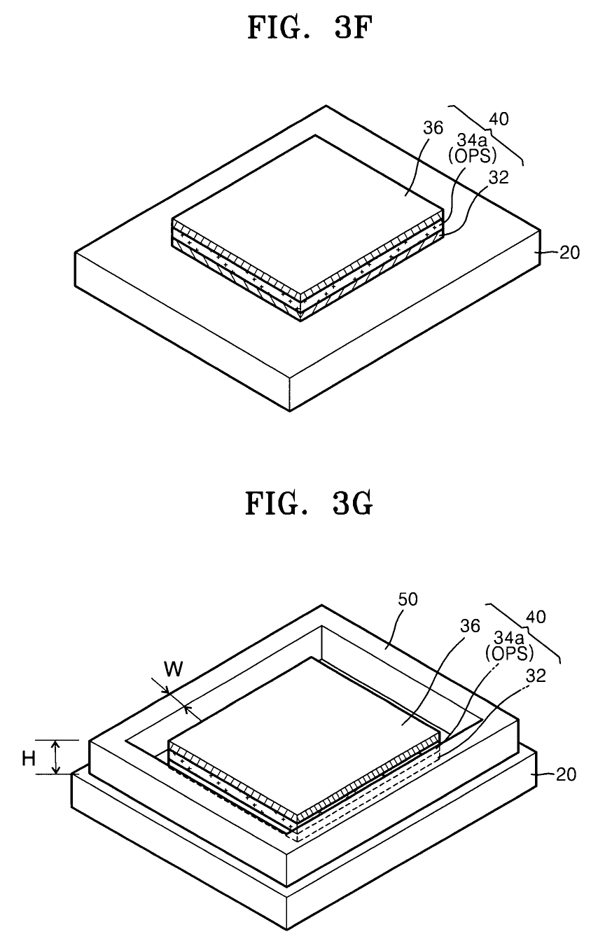

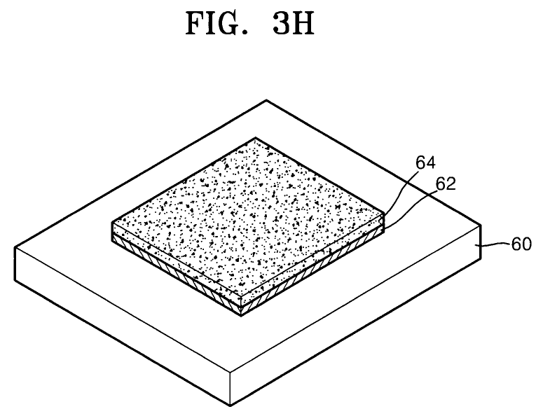

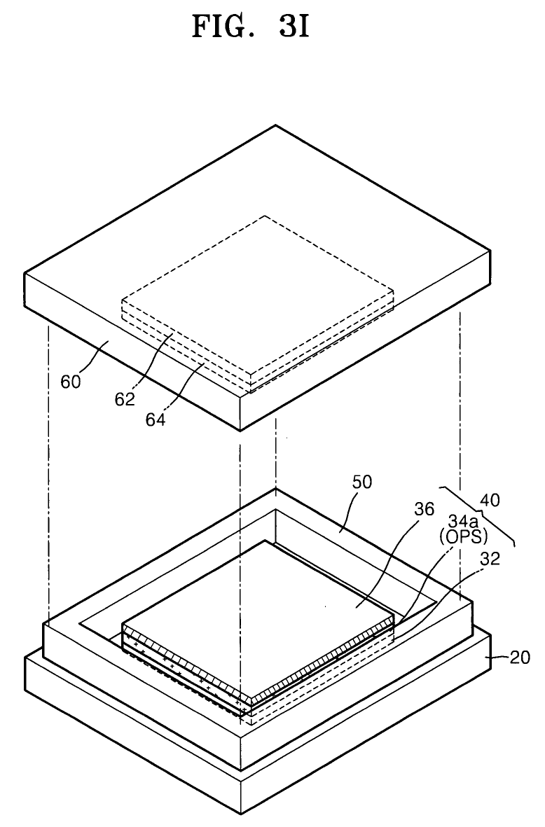

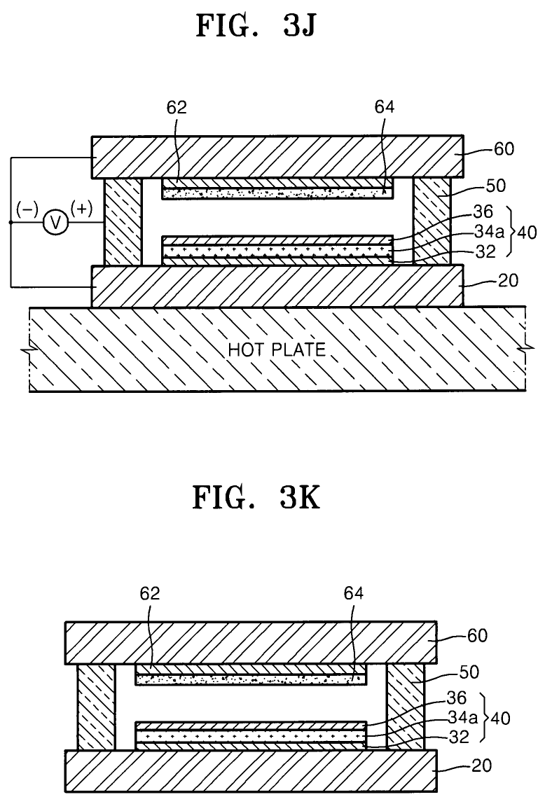

FIGS. 3A through 3K are diagrams illustrating manufacturing process of a display device, which includes an oxidized porous silicon (OPS) material-based emission source, constructed as an embodiment of the present invention. In the processes of manufacturing the display device having an OPS material-based emission source, various material layers can be formed by various thin film deposition techniques which are widely used in the manufacturing processes of semiconductor devices or PDPs. Examples of the thin film deposition techniques include physical vapor deposition, chemical vapor deposition, spray coating, screen printing, and so on.

Referring to FIG. 3A, first panel 20 and a second panel (not shown) are prepared. Each of first panel 20 and the second panel includes sodium oxide (Na₂O) or potassium oxide (K₂O). First panel 20 and the second panel are preferably made of glass or a plastic material having a coefficient of thermal expansion that is substantially the same as a coefficient of thermal expansion of silicon. Example of the glass includes low expansion borosilicate glass sold under the trademark Pyrex 7740 glass.

Referring to FIGS. 3B through 3F, OPS material-based emission source 40 is formed on an inner surface of first panel 20. In more detail, as shown in FIG. 3B, cathode electrode 32 is formed on the first panel 20 using a conductive material such as indium tin oxide (ITO), aluminum (Al), or silver (Ag). Then, silicon layer 34 is formed on cathode electrode 32 as shown in FIG. 3C. Silicon layer 34 is then anodized to be converted into oxidized porous silicon (OPS) layer 34a as shown in FIG. 3D. Since anodizing is a well-known technology in the art, a detailed explanation thereof will not be given. In the current embodiment of the present invention, a mixed solution of hydrofluoric acid (HF) and ethanol was used as an etchant during the anodizing process. OPS layer 34a is made through the anodizing process as shown in FIG. 3E. Thereafter, grid electrode 36 is formed using a conductive material such as indium tin oxide (ITO), aluminum (Al), or silver (Ag) as shown in FIG. 3F. Through these processes described above, OPS material-based emission source 40 is formed on the first panel 20.

Referring to FIG. 3G, silicon (Si) is deposited on first panel 20 to form silicon spacer 50 on first panel 20. Silicon spacer 50 is formed outside periphery of OPS material-based emission source 40, and encloses OPS material-based emission source 40. Silicon spacer 50 has height H and width W, each of which is no greater than 100 μm (micro-meters). Preferably each of height H and width W is no greater than 10 μm.

Referring to FIG. 3H, anode electrode 62, which is made of a transparent conductive material such as ITO, is formed on an inner surface of second panel 60. Then, phosphoric substance is formed on anode electrode 62 to form phosphor layer 64. A stack of anode electrode 62 and phosphor layer 64, together with OPS material-based emission source 40 that faces the stack of anode electrode 62 and phosphor layer 64, constitutes a unit cell or a unit pixel of the display device of the present invention.

Referring to FIGS. 3I and 3K, second panel 60 is assembled with first panel 20 through silicon spacer 50 in a manner that inner surfaces of first panel 20 and second panel 60 face each other. In the first step of the assembly process, second panel 60 is disposed on silicon spacer 50 to face first panel 20. Then, first and second panels 20 and 60 are heated to temperature of approximately 200° C. or higher on a hot plate. A direct current (DC) voltage is applied to each of first panel 20, second panel 60, and silicon spacer 50 for anodic bonding. In this case, it is required that a first negative (−) DC voltage is applied to first panel 20, a second negative (−) DC voltage is applied to second panel 60, and a positive (+) DC voltage is applied to silicon spacer 50. The first negative DC voltage and the second negative DC voltage can have the same or different magnitude. Particularly, it is preferred that the DC voltage, which is applied to first panel 20, second panel 60, or silicon spacer 50, is 600 V or higher. The anodic bonding can be performed in a vacuum. During the assembly process of the display panel, contamination due to presence of impurities can be avoided by performing anodic bonding in a vacuum, thereby maintaining the bonding strength at a considerably high level.

In the anodic bonding process, first and second panels 20 and 60 made of, for example, low expansion borosilicate glass sold under the trademark Pyrex 7740 glass, contain a sodium oxide (Na₂O) or potassium oxide (K₂O) component. If the glass is heated at temperature of approximately 200° C. or higher, sodium oxide (Na₂O) or potassium oxide (K₂O) is ionized, so that sodium ions (Na⁺) or potassium ions (K⁺) are produced in the glass. The produced sodium ions (Na⁺) or potassium ions (K⁺) can easily migrate along applied electric field. When a DC voltage of 600 V or higher is applied to each of first panel 20, second panel 60, and silicon spacer 50, Na ions (Na⁺) or potassium ions (K⁺) rapidly moves being driven by applied voltage. Negatively charged particles that cannot be easily movable may remain on the surfaces of first and second panels 20 and 60 adjacent to silicon spacer 50. Accordingly, strong antistatic or electrostatic force is generated at an interface between first panel 20 and silicon spacer 50 and at an interface between second panel 60 and silicon spacer 50.

A chemical bond of silicon-oxygen-silicon (Si—O—Si) is produced at these interfaces. As the result, it is possible to remove gaps or cavities caused by surface roughness, which may occur at the each interface between first panel 20 and silicon spacer 50 and between second panel 60 and silicon spacer 50, thereby establishing hermetical sealing and bonding between first panel 20 and silicon spacer 50 and between second panel 60 and silicon spacer 50. Strength of anodic bonding is considerably high, and time required to process the anodic bonding is relatively short. The time for anodic bonding process ranges from about several seconds to about several minutes depending on panel size. In particular, since the anodic bonding is performed in a vacuum, the anodic bonding the prevents contamination caused by impurities during packaging processes of a display panel, and the bonding strength can be maintained at a considerably high level.

In the contemporary packaging technology of display devices such as PDPs or FEDs, organic paste is heated at high temperature of approximately 400° C. or higher to bond upper and lower panels together. In the heating process, organic paste is drained from the discharge cells in the form of a gaseous phase, so that it may contaminate the surface of the OPS layer, thereby undesirably degrading electron emission characteristics of the OPS layer. According to the present invention, in which the upper and lower panels are packaged using anodic bonding, however, since the organic paste is not necessarily used, the heating process may be skipped. Particularly, contamination of the surface of the OPS layer can be prevented, thereby improving the electron emission efficiency of the OPS layer. Accordingly, the display device of the present invention has higher luminous efficiency than the contemporary display device. In addition, since anodic bonding is performed after forming a spacer by depositing a thin film made of silicon to a desired thickness, it is easy to control a gap between the upper and lower panels to less than or equal to several tens of micrometers. In contemporary PDP or FED manufacture processes, tubes are required to create a vacuum after bonding the upper and lower panels. According to the present invention, however, since the panel packaging process using anodic bonding is performed in a vacuum, no evacuation tube is required.

As described above, since a display device of the present invention including an OPS material-based emission source is manufactured using anodic bonding, electron emission characteristics of an OPS layer can be improved by suppressing contamination of a surface of the OPS layer during a bonding process of first and second panels of the display device. In addition, since a gap between the first and second panels is easily controlled to less than or equal to several tens of micrometers, miniaturization and compactness of a display device can be advantageously achieved.

Further, since tubeless packaging of the first and second panels is performed during the bonding process, the display device including an OPS material-based emission source can be manufactured in an easy, simplified manner.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of manufacturing a display device comprising:
preparing a first panel that includes a material selected from the group consisting of sodium oxide (Na₂O) and potassium oxide (K₂O);
preparing a second panel that includes a material selected from the group consisting of sodium oxide (Na₂O) and potassium oxide (K₂O);
forming an oxidized porous silicon material-based emission source on an inner surface of the first panel;
forming a silicon spacer on the inner surface of the first panel, the silicon spacer enclosing the oxidized porous silicon material-based emission source; and
anodic bonding the second panel to the silicon spacer in a manner that an inner surface of the second panel faces the inner surface of the first panel.

2. The method of claim 1, wherein each of the first panel and the second panel is made of a material selected from the group consisting of glass and a plastic material, each of which has a coefficient of thermal expansion being substantially the same as a coefficient of thermal expansion of silicon.

3. The method of claim 2, comprised of the glass including low expansion borosilicate glass.

4. The method of claim 1, comprised of the step of forming the oxidized porous silicon material-based emission source comprising:
forming a cathode electrode on the inner surface of the first panel;
forming an oxidized porous silicon layer on the cathode electrode; and
forming a grid electrode on the oxidized porous silicon layer.

5. The method of claim 4, comprised of the step of forming the oxidized porous silicon layer comprising:
forming a silicon layer on the cathode electrode; and
anodizing the silicon layer to convert the silicon layer into the oxidized porous silicon layer.

6. The method of claim 1, comprised of the silicon spacer having a height no greater than 100 micro-meters.

7. The method of claim 6, comprised of the silicon spacer having the height no greater than 10 micro-meters.

8. The method of claim 1, comprised of the silicon spacer having a width no greater than 100 micro-meters.

9. The method of claim 8, comprised of the silicon spacer having the width no greater than 10 micro-meters.

10. The method of claim 1, comprised of the step of anodic bonding the second panel comprising:
heating the first panel and the second panel to temperature no less than 200° C.; and
applying a direct current voltage to each of the silicon spacer, the first panel, and the second panel.

11. The method of claim 10, comprised of the direct current voltage being no less than 600 V.

12. The method of claim 10, comprised of the step of applying a direct current voltage comprising:
applying a first negative direct current voltage to the first panel;
applying a second negative direct current voltage to the second panel; and
applying a positive direct current voltage to the silicon spacer.

13. The method of claim 1, further comprising a step of forming a phosphor layer on the inner surface of the second panel.

14. The method of claim 1, further comprising:
forming an anode electrode on the inner surface of the second panel; and
forming a phosphor layer on the anode electrode.

15. A display device comprising:
a first panel that includes a material selected from the group consisting of sodium oxide (Na₂O) and potassium oxide (K₂O);
a second panel that includes a material selected from the group consisting of sodium oxide (Na₂O) and potassium oxide (K₂O), an inner surface of the second panel facing an inner surface of the first panel;
an oxidized porous silicon material-based emission source formed on the inner surface of the first panel; and
a silicon spacer formed on the inner surface of the first panel, the silicon spacer enclosing the oxidized porous silicon material-based emission source, the second panel being bonded to the silicon spacer.

16. The display device of claim 15, wherein each of the first panel and the second panel is made of a material selected from the group consisting of glass and a plastic material, each of which has a coefficient of thermal expansion being substantially the same as a coefficient of thermal expansion of silicon.

17. The display device of claim 15, comprised of the oxidized porous silicon material-based emission source comprising:
a cathode electrode formed on the inner surface of the first panel;
an oxidized porous silicon layer formed on the cathode electrode; and
a grid electrode formed on the oxidized porous silicon layer.

18. The display device of claim 15, comprised of the silicon spacer having a height no greater than 100 micro-meters.

19. The display device of claim 15, further comprising:
an anode electrode formed on the inner surface of the second panel; and
a phosphor layer formed on the anode electrode.

20. The display device of claim 15, wherein a bond of silicon-oxygen-silicon is formed between the second panel and the silicon spacer.
